(19) United States
(12) Patent Application Publication
(10) Pub. No.: US 2016/0314502 A1
(43) Pub. Date: Oct. 27, 2016

(54) SYSTEM AND METHOD FOR STREAMLINING THE DESIGN AND DEVELOPMENT PROCESS OF MULTIPLE ADVERTISING UNITS

(71) Applicant: CONVERSANT, INC., Chicago, IL (US)

(72) Inventors: Andrew Lindsay, Glenview, IL (US); Noel Maguigad, Chicago, IL (US); Marin Petkov, Chicago, IL (US); Shatay Zoe Trigere, Chicago, IL (US); Brian D. Young, Chicago, IL (US)

(21) Appl. No.: 14/696,158

(22) Filed: Apr. 24, 2015

(51) Int. Cl. G06Q 30/02; G06F 17/30; H04L 29/08

(52) U.S. Cl. CPC G06Q 30/0276; G06Q 30/0277; H04L 67/02; H04L 67/06; G06F 17/30115; G06F 17/3028

(57) ABSTRACT

A tool provides for the batch processing of multiple ad units, allowing quickly and simultaneously reformatting assets into multiple standard online advertisement formats and exporting the ad units to an ad server with scripting code so as to save time and cost in generating an online advertising campaign. The tool may also include high level commands to allow a user to simultaneously or individually adjust an ad unit for different renderings for an online advertising campaign.

### TECHNICAL FIELD

This is an application which streamlines the design and development process of multiple advertising units. Specifically, a user can design multiple ad units in unison within a single concentrated view which is then exported as fully developed files (e.g., FLASH® or JAVASCRIPT®) which are then loaded into an ad server for publication. (JAVASCRIPT is a registered trademark of Oracle America, Inc. FLASH is a registered trademark of Adobe, Inc.)

### BACKGROUND ART

Web developers, web designers, and bloggers frequently have to deal with the challenge of converting many images to different sizes and formats. While production artists and others of ordinary skill in the art know how to convert such assets by hand, the process to do so can be extremely time consuming.

Thus, the present state of the art reflects a need for a system which easily permits a user flexible batch processing tools for assets related to advertisements for an online advertising campaign.

One example of a prior art approach is found in the Pixillion Image Converter software from Pixillion Limited. The Pixillion software can convert images, resize and rotate them, adjust the quality of JPEG files, add captions, and the like. Another example can be seen in the Advanced Batch Converter software from Gold Software. Advanced Batch Converter can convert from over 180 file types into 44 common file formats (including jpg, png, and tiff). It can also resize, rotate, flip, mirror, crop, filter, watermark, or perform other functions on images.

However, none of these prior art approaches permit a user to ability to implement the simultaneous batch processing of multiple ad units and the inclusion of scripting code to generate a fully-developed ad unit for sending to an ad server.

What is needed is simple, user friendly solution for the flexible and simultaneous processing of the placement, size, and layer compositions of multiple advertisements within an online advertising system exporting the ad units to an ad server, ready to serve.

### SUMMARY OF INVENTION

Embodiments disclosed herein generally include a tool for the batch processing of multiple Internet banner ad units, allowing quickly and simultaneously reformatting assets into multiple standard online advertisement formats and exporting the ad units to an ad server with scripting code so as to save time and cost in generating an online advertising campaign. Embodiments may also include high level commands to allow a user to simultaneously or individually adjust an ad unit for different renderings for an online advertising campaign.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a screenshot illustrating a canvas for manipulating ad units according to one embodiment.

FIG. 2 is a flowchart illustrating an ad unit creation and export process according to one embodiment.

FIG. 3 is a flowchart illustrating an ad unit creation and export process according to another embodiment.

FIG. 4 is a screenshot illustrating an images tab of a user interface panel for an ad unit creation and export tool according to one embodiment.

FIGS. 5-6 are screenshots illustrating a text formatting user interface according to one embodiment.

FIG. 7 is a screenshot illustrating adding images to an ad unit according to one embodiment.

FIG. 8 is a collection of screenshots illustrating a user interface for formatting “call to action” buttons according to one embodiment.

FIGS. 9-10 are a collection of screenshots illustrating a user interface for adding rotating headlines to an ad unit according to one embodiment.

FIG. 11 is a screenshot illustrating a user interface for adjusting a mapping of variables when exporting ad units to an ad server according to one embodiment.

FIG. 12 is a block diagram of a programmable device usable for implementing the techniques described herein according to one embodiment.

FIG. 13 is a block diagram illustrating a networked infrastructure for implementing the techniques described herein according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts are understood to reference all instance of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment. Blocks illustrated in the Figures may be combined with other blocks or split into multiple blocks as desired, and rearranged as desired. Unless otherwise indicated, use of the term “or” may refer to either or both of the alternatives expressed.

Although some of the following description is written in terms that relate to software or firmware, embodiments can implement the features and functionality described herein in software, firmware, or hardware as desired, including any combination of software, firmware, and hardware. References to daemons, drivers, engines, modules, or routines should not be considered as suggesting a limitation of the embodiment to any type of implementation.

As used herein, the term “a computer system” can refer to a single computer or a plurality of computers working together to perform the function described as being performed on or by a computer system.

As used herein, the term “medium” can refer to a single physical medium or a plurality of media objects that together store data or instructions that when executed cause a machine to perform desired actions.

Batch image processing such as that described below can reduce this process from hours of work to just a few simple clicks. Moreover, an automated batch process to create such images provides much greater flexibility to meet desired changes in the advertisements over time.

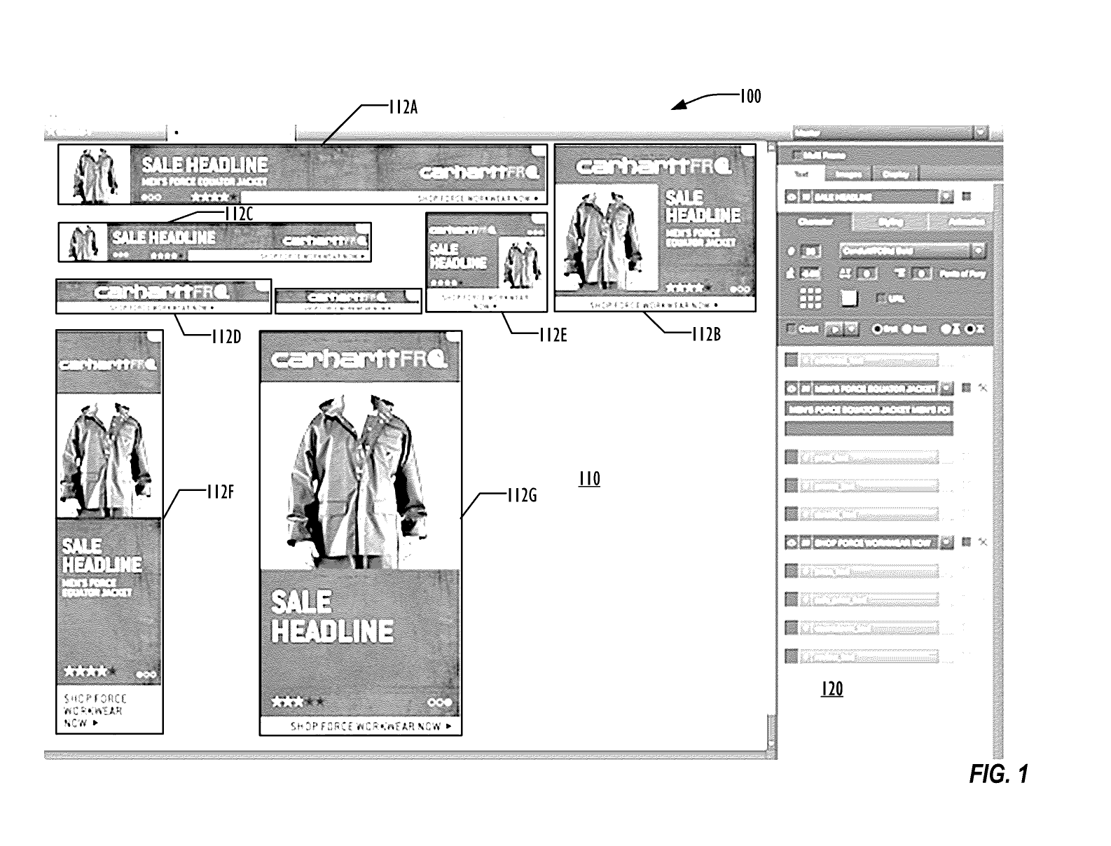

FIG. 1 is a screenshot 100 of an embodiment of an implementation of the techniques described below according to one embodiment. In this example, an artboard canvas 110 provides a workspace for a creative designer to design one or more related artboards 1 in varying sizes or shapes, using controls illustrated in user interface panel 120. Each of the artboards 112 can be manipulated together with the other artboards 112 or separately, as desired. As explained in more detail below, each of the ad units typically a graphic image and a text headline, in addition to element identifying the advertiser. Once the designer has completed his or her work with the artboards 112, an export function allows batch processing of the artboards into ad units, including automatically inserting JavaScript or Flash into the ad unit export file and sending the ad units as export files to an ad server.

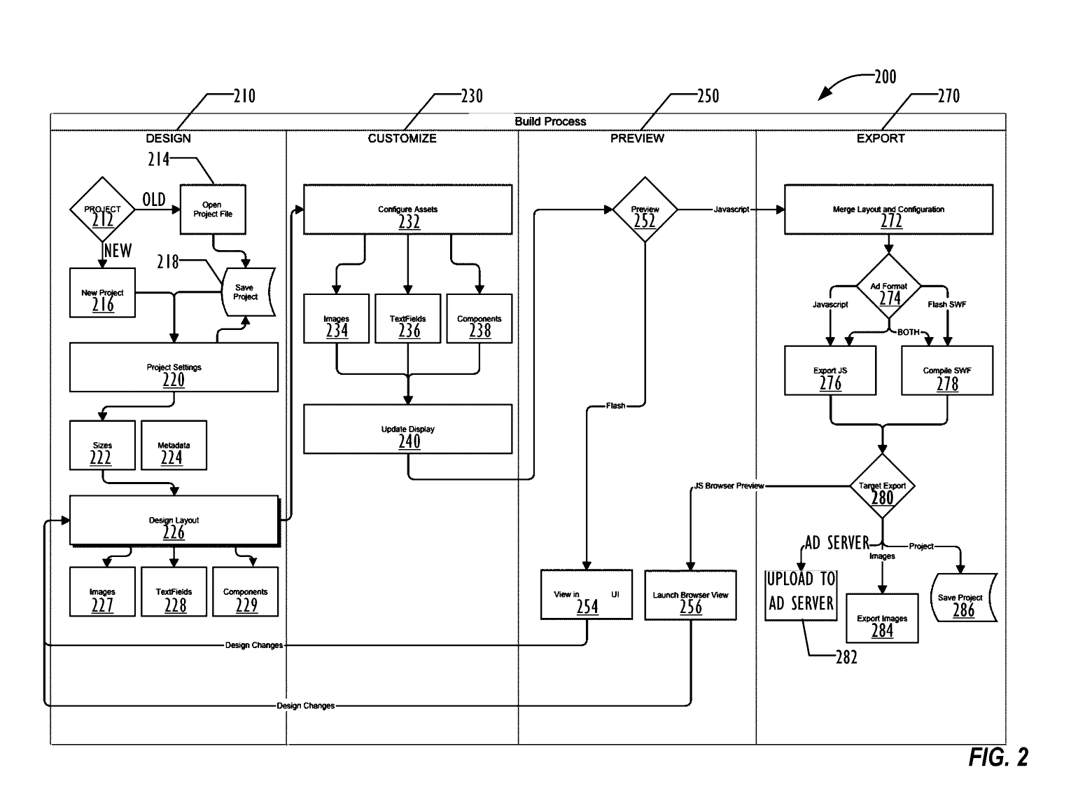

FIG. 2 is a flowchart illustrating an ad unit creation and export process 200 according to one embodiment. The flowchart is organized in four sections: Design 210, Customize 230, Preview 250, and Export 270. Although the focus of this disclosure is on Export 270 section, the other sections will be generally described.

In the Design section, the creative designer begins working on a project. If the project is an existing project, as determined in block 212, then a saved project file may be opened in block 214, otherwise a new project may be created in block 216 and then opened. Once the project is opened, project settings may be determined in block 220. The project and its settings may be saved in block 218. The sizes and other metadata associated with the project may be determined in block 222 and 224, respectively. A design layout may be created in block 226, resulting in images 227, text fields 228, and other components 229. The design layout may be preexisting standard layout. The process then moves to the customization section or phase 230.

In this phase, the creative designer can configure assets in block 232 into the various artboards 112 in the artboard canvas 110, as illustrated in FIG. 1. This may involve inserting images 234, text fields 236, and other components 238 into the various artboards 112. The updated artboards may then be displayed in block 240, before moving onto the Preview section 250.

Although Flash is becoming less used over time, if the previewer desires to preview a Flash version of the ad units as determined in block 252, Flash code may be coupled to the artboards and the resulting ad unit displayed in the user interface in block 254. If changes to the design are desired after previewing the ad units, the process returns to block 226 to adjust the design layout.

The most common scripting language used today for ad servers is the JavaScript scripting language. Although the following is written in terms of use of JavaScript, other scripting language may be used as desired.

If a JavaScript preview is desired or if no preview is desired and the ad units are ready for export to an ad server, then the export phase 270 begins in block 272 by merging the layout and configuration objects. Then in block 274 the desired ad unit format is checked. If the desired ad unit format is Flash, Flash Small Web Format (SWF) code is added to the merged layout and configuration data and compiled into an SWF file in block 278. If a JavaScript format ad unit is desired, then JavaScript code is added to the merged layout and configuration data and exported as a JavaScript file in block 276. In either format, the export file contains executable code for displaying the images and text of the artboard that correspond to the ad unit in a browser.

Then, in block 280 the target of the export is determined. If a browser preview of the JavaScript file is desired, then a browser view is launched in the user interface in block 256 of the Preview section 250. If changes are desired after previewing the ad units, the process can return to block 226 to continue designing the layout.

In the example embodiment illustrated in FIG. 2, three other alternatives are available. If the ad units are to be exported to an ad server, then in block 282 the ad units are uploaded to the ad server, where they can be served as advertisements. If the ad units are to be exported as static images, then that export is performed in block 284, extracting the images from the ad units, removing the inserted JavaScript or Flash code, and saving just the static images as image files. If the project is to be saved to a file, the file can be saved as a project file in block 286.

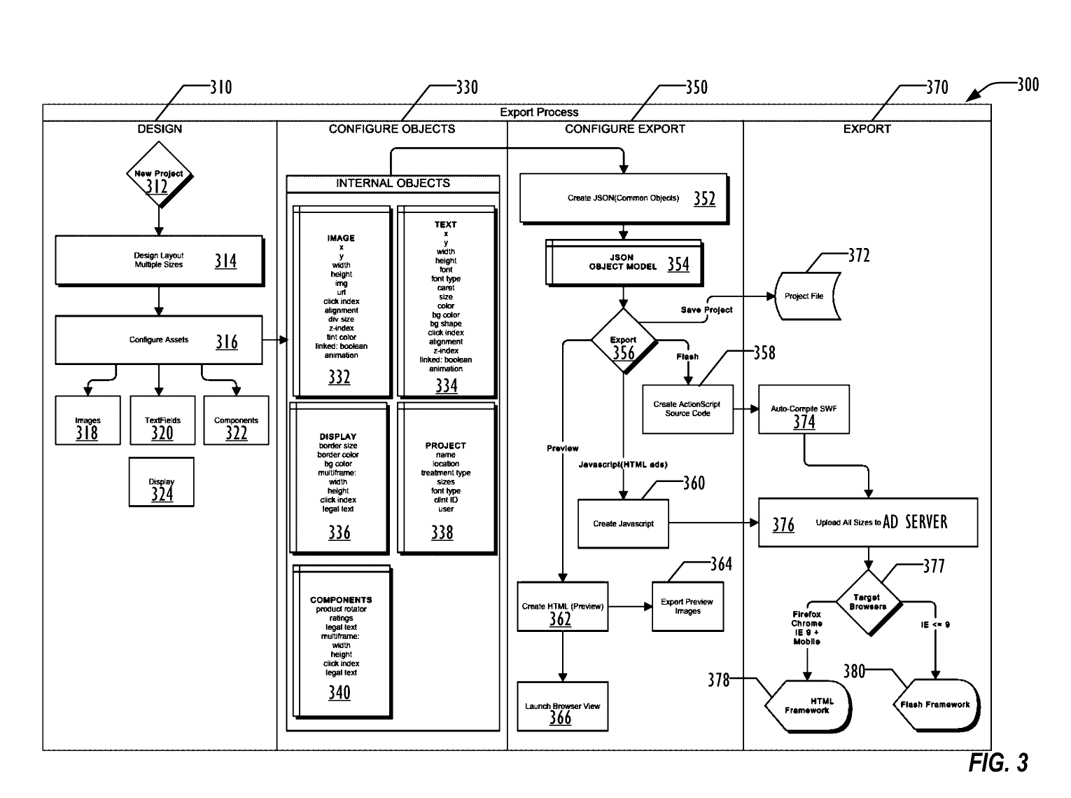

FIG. 3 is a flowchart illustrating a process 300 for creating and exporting ad units according to another embodiment. In this illustration, the process 300 is divided into four sections: Design 310, Configure Objects 330, Configure Export 350, and Export 370. The Design section 310 begins with a decision to create a new project in block 312. In block 314, the design layout is created on the artboard canvas 110 in multiple sizes as desired. Assets are then configured in the several artboards 112 in block 316, involving images 318, text fields 320, other components 322, and displays 324.

In the configure objects 330 phase, internal objects are created based on the configuration of the project performed in the design phase 310. In one embodiment, for image objects 332, the variables include X and Y position, width, height, an image Uniform Resource Locator (URL), a click index, alignment information, a divisor size, a Z-axis index, tint, color, whether the object is linked to another object, and animation information. For text objects 334, in one embodiment the variables include X and Y position, width, height, font, font type, caret, size, color, background color, background shape, click index, alignment, Z-axis index, whether the object is linked to another object, and animation information.

In one embodiment, display objects 336 variables include border size, border color, background color, multiframe width and height, click index, and legal text information. In one embodiment project objects 338 variables include a project name, location, treatment type, sizes, font type, a clint ID, and a user name. In one embodiment, components objects 340 variables include a product rotator, ratings, legal text, multiframe width and height, a click index, and legal text information. These variables are illustrative and by way of example only, and other variables and objects may be used as desired.

When the creatives designer wants to export the ad units for the project, the internal objects 332-340 are used in blocks 352-354 to create a JavaScript Object Notation (JSON) format file, which is a self-identifying object notation comprising an attribute-value pair data interchange format based on a subset of the JavaScript programming language. The JSON format file can then be exported based on an evaluation in block 356 that decides what type of export is desired.

If export to a project file is desired, the JSON file can be saved to a project file in block 372. If a preview is desired, in block 362 a HyperText Markup Language (HTML) file is created from the export file. Preview images may be exported in block 364 and in block 366 a browser may be launched to view the HTML file created from the JSON file, allow a user to preview how the ad units will look in a browser, which is the expected way in which advertisements are to be seen by the people to whom advertisements are targeted.

In some embodiments, export to an ad server may involve creating both Flash and JavaScript versions of the ad units. Because Flash is significantly less used today, some embodiments may eliminate the ability to create Flash versions. Where Flash versions are desired, in block 358 ACTIONSCRIPT® source code is created and compiled into an SWF file in block 374, which then is uploaded in block 376 to the ad server. All sizes and shapes of the artboards 112 configured on the artboard canvas 110 are converted to SWF files and uploaded to the ad server automatically, without additional intervention by the creative designer.

Similarly, in block 360 the JSON object model file is modified to include JavaScript code for displaying HTML ads, and uploaded to the ad server in block 376. As with Flash files, all sizes and shapes of the artboards 112 configured on the artboard canvas 110 are converted to JavaScript files and uploaded to the ad server, without additional intervention by the creative designer.

The ad server may then provide the appropriate ad unit when serving advertisements, based on determining in block 377 the target browser. If the target browser is capable of handling JavaScript, then in block 378 the JavaScript version of the ad unit is served. If the target browser is not capable of handling JavaScript, such as an older release of a browser, the Flash framework 380 may be used to serve a Flash version of the ad unit. In some embodiments, because most, if not all, current browsers can support JavaScript and Flash is deprecated, the ad server may choose to provide ad units only in JavaScript format.

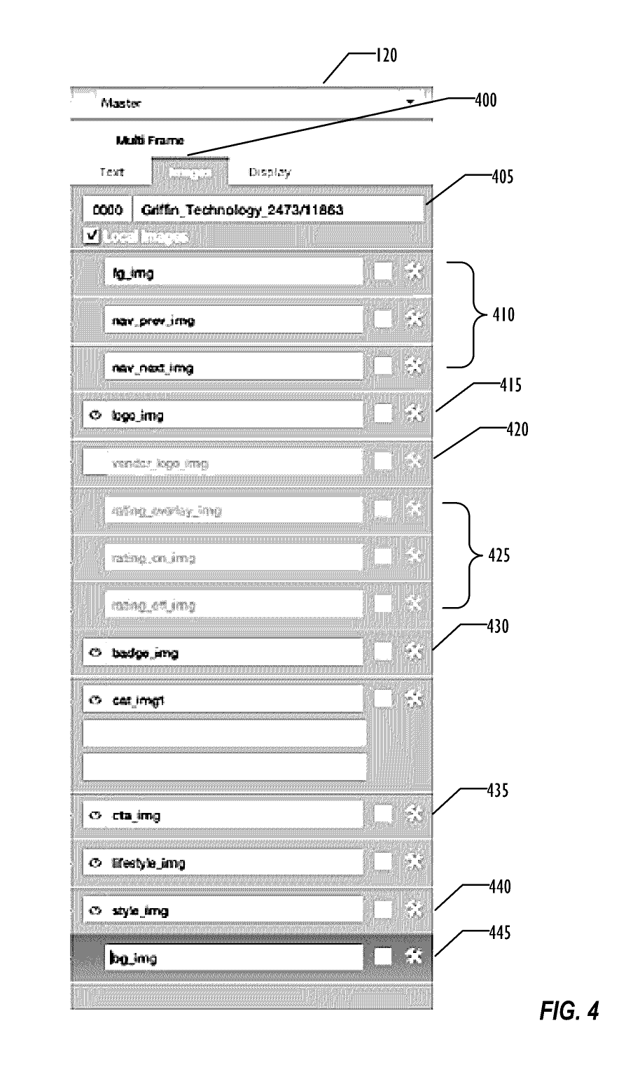

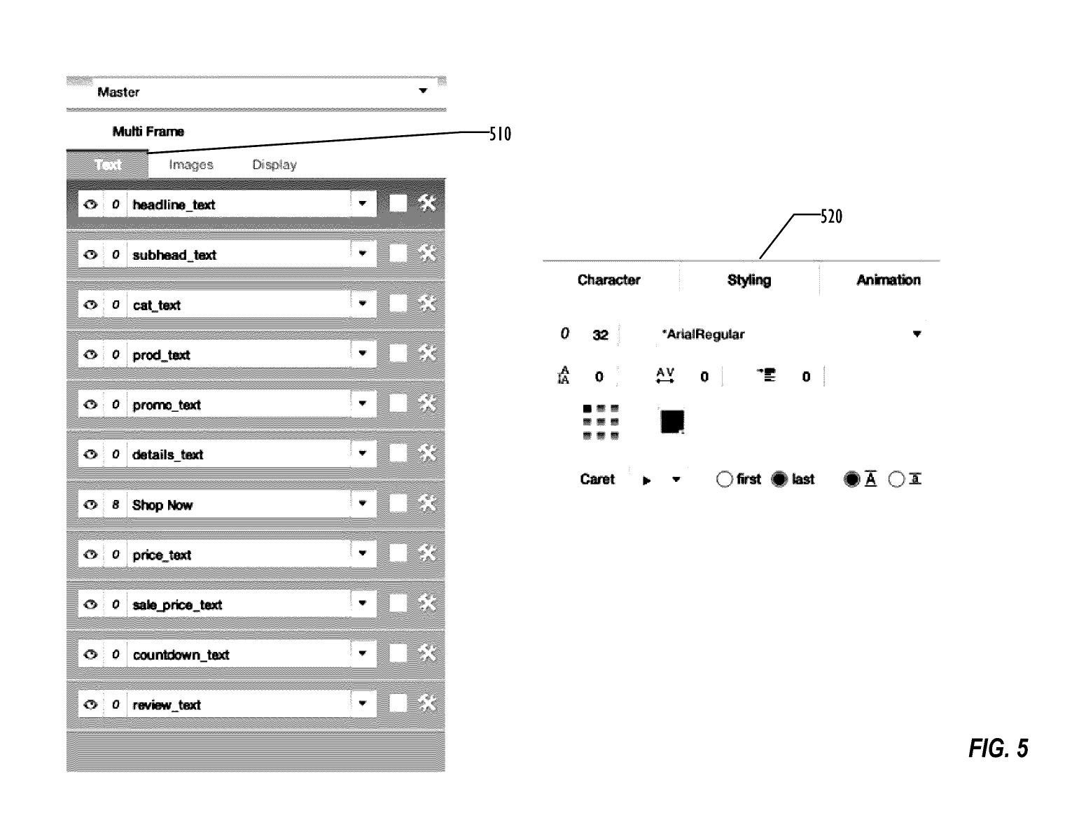

FIG. 4 is a screenshot of an images tab 400 of the user interface panel 120 for designing ad units according to one embodiment. The user interface panel 120 includes 3 tabs that allow the creatives designer to bring a dynamic banner together. The first one is the Text Tab that allows the designer to input text and format it. (See FIG. 5.) The second tab is the Images tab 400 that allows the designer to input graphic assets by layer using saved assets. The way that layers are ordered is the way that they are going to be layered in the banner. The final tab is the Display Tab, which offers further customization tools like default background color and legal text.

In the Images tab 400, various field and controls are provided. Field 405 identifies a client ID and a folder where images are to be found. Fields 410 specify file names for a foreground image layer as well as layers for navigation arrows. Field 415 specifies an image for a logo layer, while field 420 specifies a vendor logo layer image. Fields 425 specify images for ratings customization layers. while field 430 specifies a badge image layer. A Call To Action (CTA) button layer 435 provides an image for CTA buttons, a style image layer 440 specifies an image for a style layer, and a background image layer 445 specifies an image for a background layer. These images and layers are illustrative and by way of example only, and other images, layers, and arrangement of elements on the user interface panel 400 may be used.

A screenshot of text tab 510 of the interface panel 120 is illustrated according to one embodiment in FIG. 5. The text tab 510 controls which dynamic text fields are available and how those fields are formatted. Designers may not use all of the dynamic text fields and if a dynamic text field is marked as unavailable, that text field does not appear in the text manipulation area 520 when the designer is working with the artboards 112. The text controls can include any useful type of text control, such as font, font size, leading, color, etc.

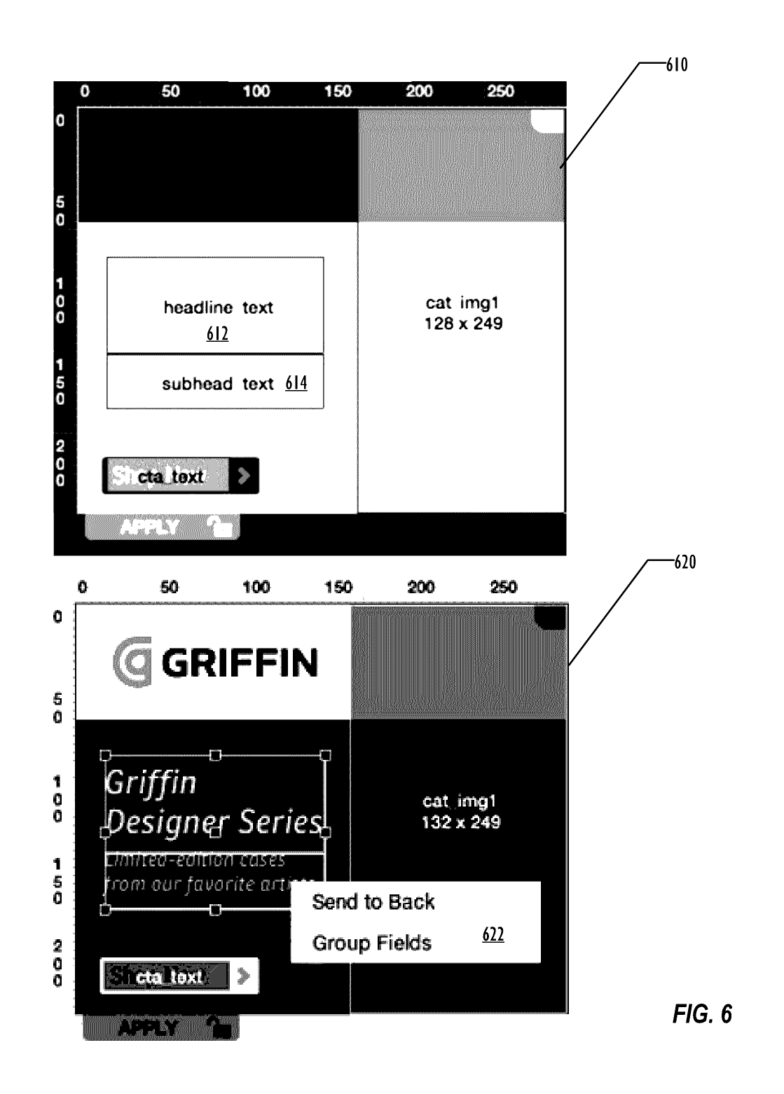

FIG. 6 is a pair of screenshots 610 and 620 that illustrate formatting text fields. Text fields in one embodiment function as one. To edit text boxes, font colors, etc., for all sizes, a designer may click in the canvas 110 outside of the artboards 112. Specific artboard changes may be made to override the master settings. In this example, a banner being built in screenshot 610 has two main dynamic text fields 612 and 614. These text fields 612, 614 work together one they are grouped. If the subhead field 614 is eliminated, the headline_text field 612 expands to fill the space, taking over the subhead space. Text fields can be moved and adjusted according to the space and desired layout. Screenshot 620 includes text in both fields 612 and 614. By clicking on both fields, then right clicking the mouse and selecting the Group Fields box 622, fields 612 and 614 can be grouped. Grouped fields may be ungrouped using a similar action.

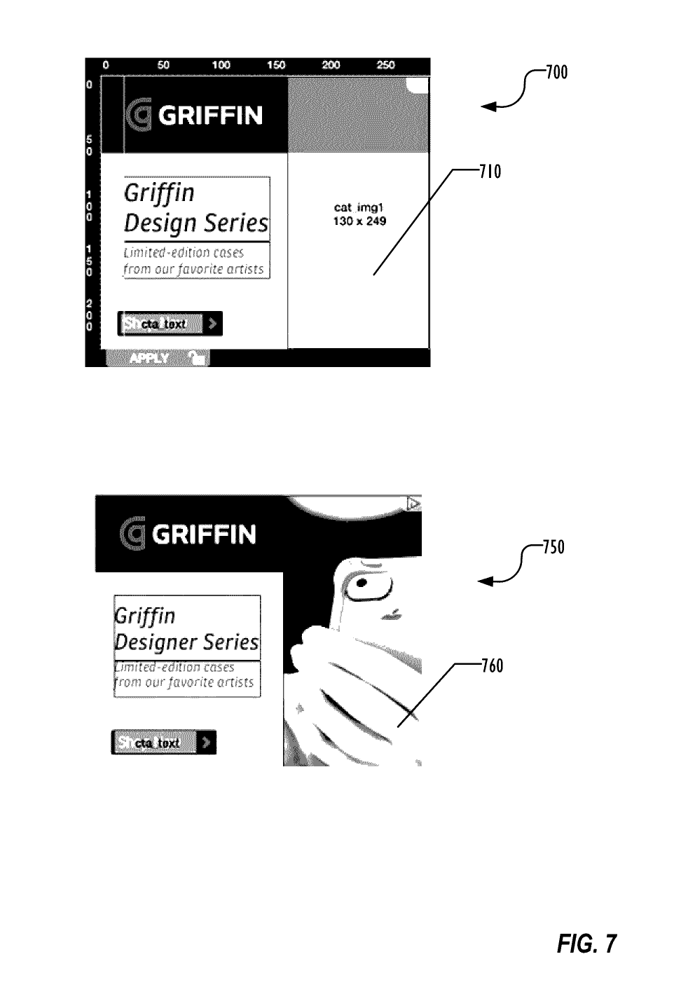

FIG. 7 is a pair of screenshots illustrating including of images into an artboard 112. Embodiments can create banner ad units that display images that are part of a filesystem accessible to the computer performing the artboard manipulation, as well as images identified by a URL that allows feeding an image dynamically into a multi-product banner. In screenshot 700, an area 710 is provided in the artboard. In screenshot 750, the area 710 has been filled in with an image 760, using the Images tab 400 of the interface panel 120.

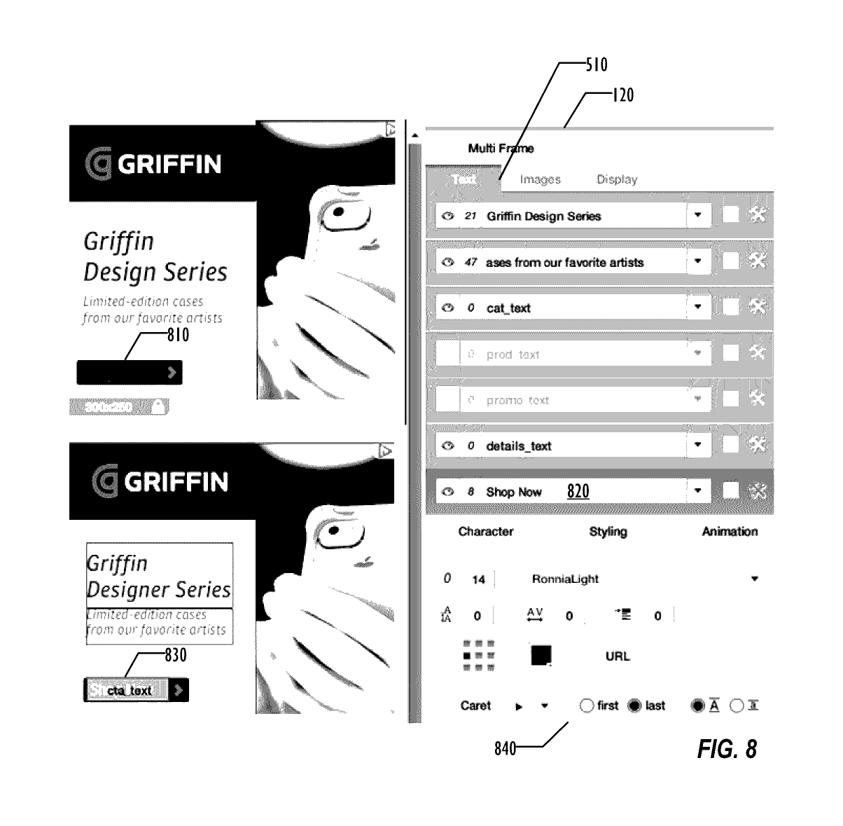

Similarly, as illustrated in FIG. 8, CTA buttons can be included in the multiple artboards 112 on the canvas 110. In one embodiment, a button image 810 can be placed in the artboards 112 by specifying an image file in CTA image field 435 of the Images tab 400 of the user interface panel 120. Text for the CTA button may be defined using the Text tab 510 of the user interface panel 120. Specifying the CTA text in field 820 results in the text 830 overlaying the CTA button image. A text formatting interface 840 allows formatting the text defined in field 820, similar to how other text fields can be formatted.

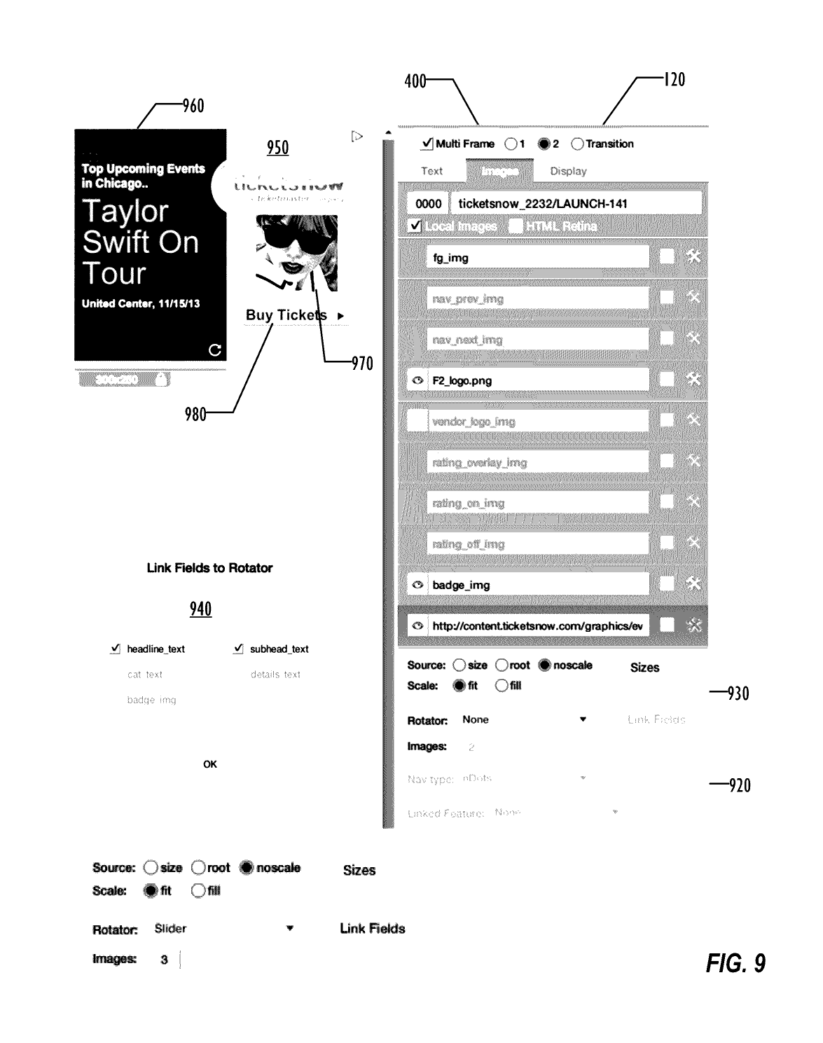

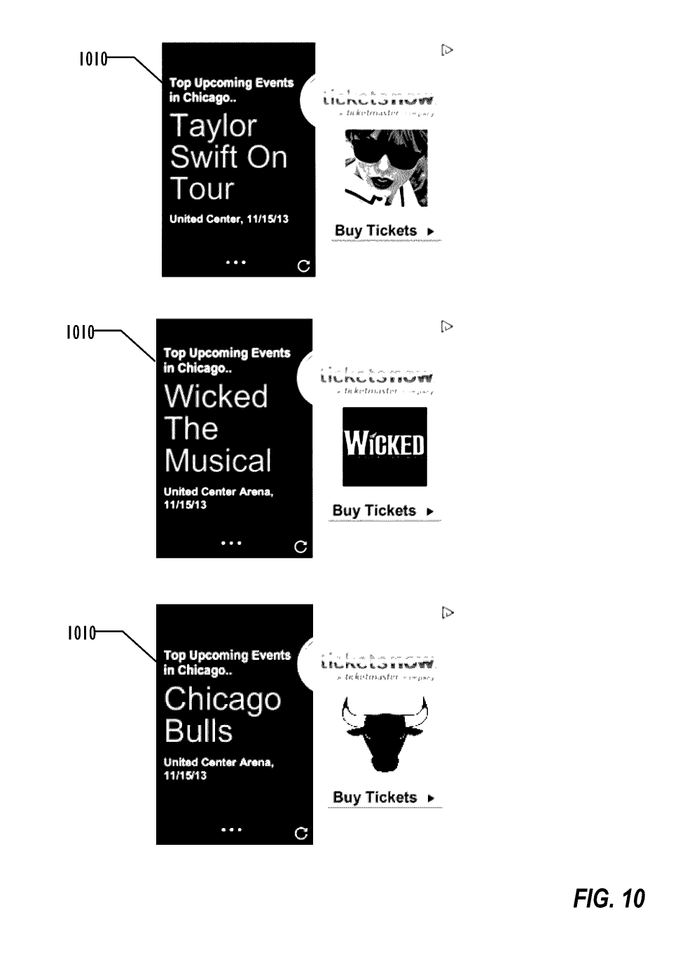

FIG. 9 illustrates support for rotating headlines that can be linked with an image according to one embodiment. Once a designer has copy for headlines and is ready to add and link different headlines to different images, the designer can click on image tab 400 of the user interface panel 120. As illustrated in FIG. 9, clicking on a Rotator field 910 pull down menu expands the menu with options for the rotator, such as the Slider choice 920. Once a slider has been selected as the rotator on the banner, the designer may input the number of images to show on the banner that will be accompanied by the linked fields. The designer may then ink fields to use as rotators with specific URLs or images. In one embodiment, when a link fields button 930 is clicked, a window 940 may pop up and provide options for determining which images to link with the dynamic rotator. For example, artboard 950 illustrates a slider rotator 980, which is linked to image 970 and text 960. The image 970 and text 960 may change, rotating to other text and images, while keeping the same rotator 980, as illustrated in FIG. 10. As illustrated in FIG. 10, a portion of the text 1010 may be used as a non-rotating headline that remains still without any animation.

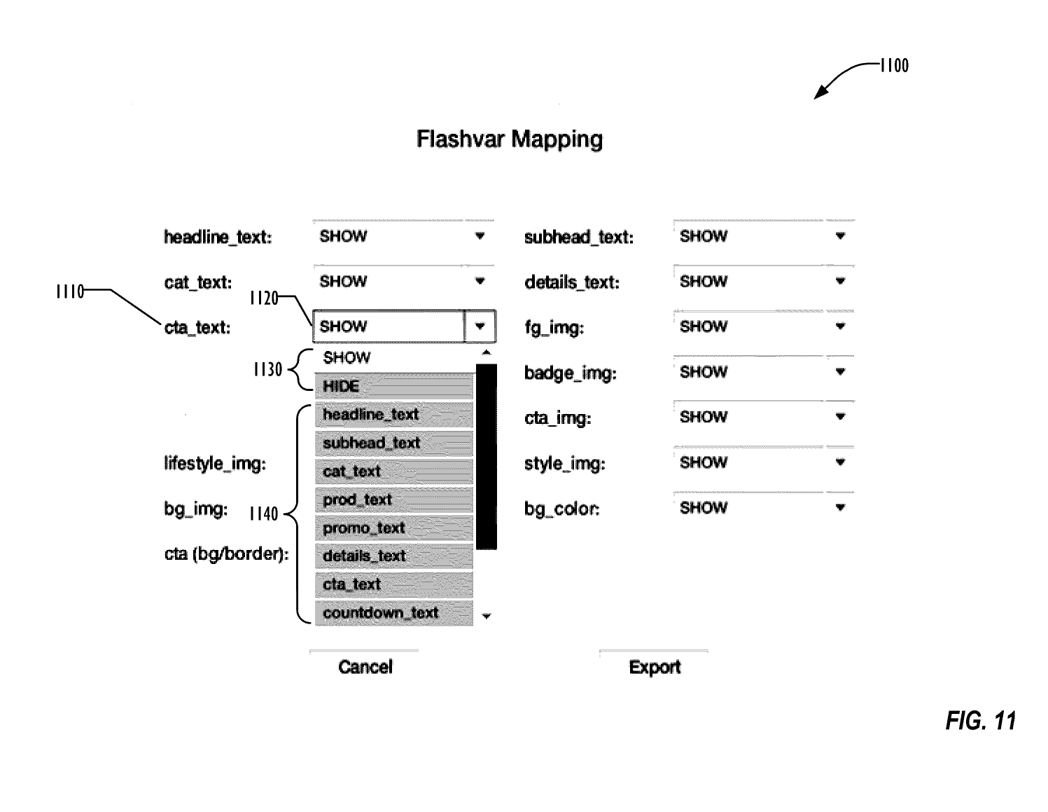

FIG. 11 illustrates a mapping 1100 of Flash variables on export from the software to the ad server according to one embodiment. When exporting, while in most scenarios the default settings are acceptable, the software allows remapping Flash variables when needed or desired in one embodiment. In the example illustrated in FIG. 11, the CTA text variable 1110 cta_text is being remapped, by selecting the pull-down menu 1120, shown opened. In areas 1130, the cta_text variable may be selected for showing or hiding. The variable exists in the exported ad unit, but is not exposed for editing. In addition, in one embodiment the variable may be remapped to a different variable, by selecting one of the entries 1140. In some embodiments, the original variable mapping may remain in the project, but values given to that field may populate into the variable that was selected for the alternate mapping.

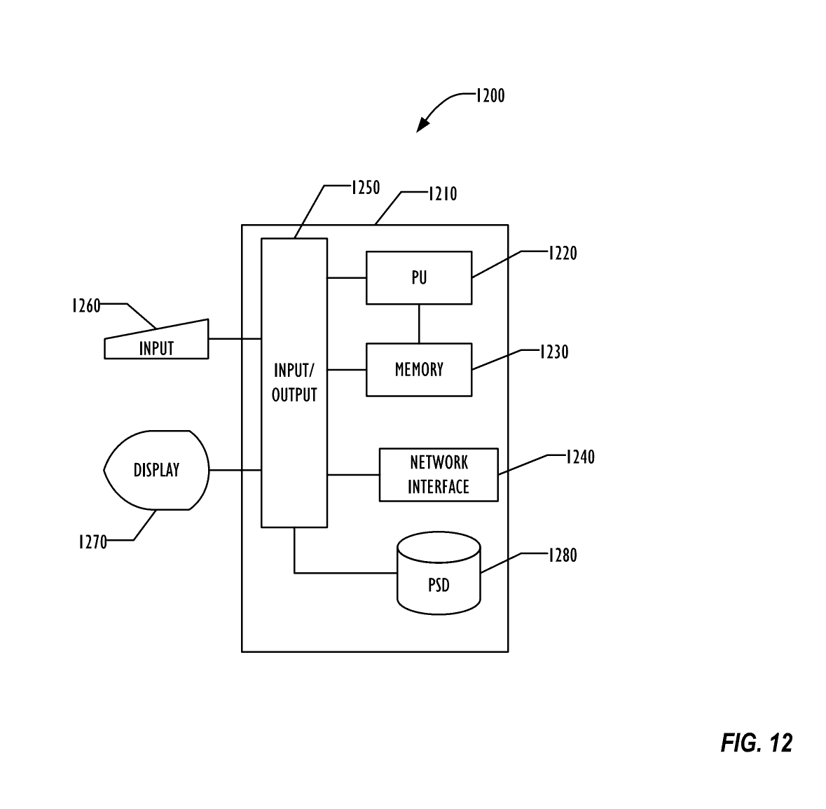

Referring now to FIG. 12, an example computer 1200 for use in providing an ad unit design tool as described above is illustrated in block diagram form. Example computer 1200 comprises a system unit 1210 which may be optionally connected to an input device or system 1260 (e.g., keyboard, mouse, touch screen, etc.) and display 1270. A program storage device (PSD) 1280 (sometimes referred to as a hard disc) is included with the system unit 1210. Also included with system unit 1210 is a network interface 1240 for communication via a network with other computing and corporate infrastructure devices (not shown). Network interface 1240 may be included within system unit 1210 or be external to system unit 1210. In either case, system unit 1210 will be communicatively coupled to network interface 1240. Program storage device 1280 represents any form of non-volatile storage including, but not limited to, all forms of optical and magnetic, including solid-state, storage elements, including removable media, and may be included within system unit 1210 or be external to system unit 1210. Program storage device 1280 may be used for storage of software to control system unit 1210, data for use by the computer 1200, or both.

System unit 1210 may be programmed to perform methods in accordance with this disclosure (examples of which are in FIGS. 2-3). System unit 1210 comprises a processor unit (PU) 1220, input-output (I/O) interface 1250 and memory 1230. Processing unit 1220 may include any programmable controller device including, for example, one or more members of the Intel® Core processor families from Intel Corporation, although other programmable controller devices may be used as desired. (INTEL and INTEL CORE are registered trademarks of Intel Corporation.) Memory 1230 may include one or more memory modules and comprise random access memory (RAM), read only memory (ROM), programmable read only memory (PROM), programmable read-write memory, and solid-state memory. One of ordinary skill in the art will also recognize that PU 1220 may also include some internal memory including, for example, cache memory.

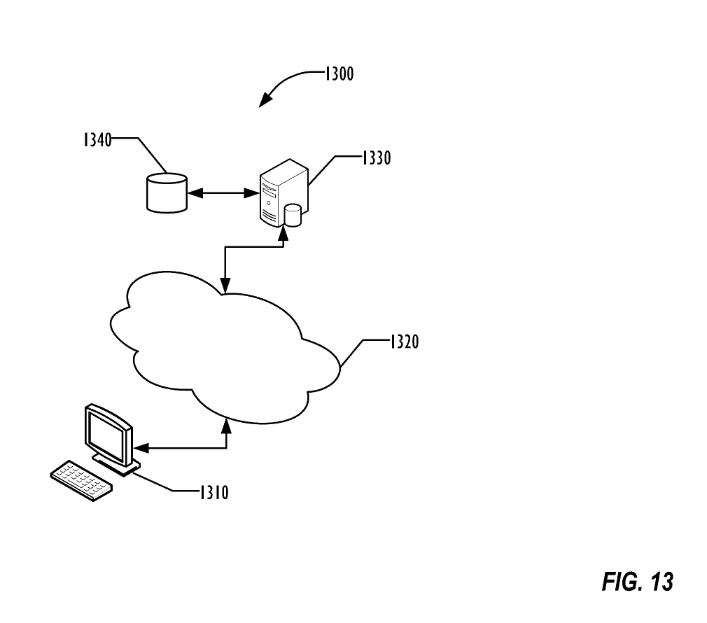

FIG. 13 is a block diagram illustrating a simplified network infrastructure 1300 for use with the systems described above. In this example, the designer at workstation 1310 performs the design and export actions described above. The designer workstation 1310 is connected via one or more networks 1320 to ad server 1330 and ad unit database 1340 which store ad units for serving on behalf of advertisers as banner ads. The ad server database 1340 may be local to or remote from the ad server 1330, and may be stored in any form of database or filesystem that may be desired or convenient. The workstation 1310 may access other sources of images and text that may be connected via the one or more networks 1320. In some embodiments, the other sources of images and text may connect to the workstation 1310 by different networks than are used to connect to the ad server 1330 and ad unit database 1340. The network(s) 1320 may be any type of computer network, including local area networks and wide area networks such as the Internet. Multiple designer workstations 1310 may connect to one or more ad servers 1330 and ad unit databases 1340. Similarly, one or more ad servers 1330 may connect to one or more ad unit databases 1340, some of which may be shared between ad servers 1330. Other workstations and servers may be connected to the one or more networks 1320 as desired.

The above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

We claim:

1. A computer system for designing Internet banner ad units, comprising:
a programmable controller device;
a memory, coupled to the programmable controller device, on which are stored instructions, comprising instructions that when executed cause the programmable controller device to:
present a user interface configured for designing a plurality of artboards of varying sizes or shapes in an artboard canvas;
modify the plurality of artboards according to an instruction received via the user interface, the instruction applied to all of the plurality of artboards;
generate a plurality of export files, each corresponding to an artboard of the plurality of artboards and each comprising executable code for displaying images and text of the corresponding artboard in a browser, responsive to an instruction received via the user interface to export the plurality of artboards; and
export the plurality of export files to an ad server.

2. The computer system of claim 1, wherein the executable code comprises code in a scripting language.

3. The computer system of claim 1, wherein the instructions that when executed cause the programmable controller device to generate the plurality of export files comprise instructions that when executed cause the programmable controller device to generate a first export file and a second export file, both corresponding to an artboard of the plurality of artboards, the first export file comprising executable code in a first programming language and the second export file comprising executable code in a second programming language.

4. The computer system of claim 1, wherein the instructions that when executed cause the programmable controller device to generate the plurality of export files comprise instructions that when executed cause the programmable controller device to:
convert the plurality of artboards into a self-defining object notation; and
incorporate executable code in a scripting language related to the self-defining object notation into the plurality of export files.

5. The computer system of claim 4, wherein the self-defining object notation is based on a subset of the scripting language.

6. The computer system of claim 1, wherein the instructions further comprise instructions that when executed cause the programmable controller device to:
preview an export file of the plurality of export files in a browser executing on the computer system.

7. The computer system of claim 1, wherein the instructions further comprise instructions that when executed cause the programmable controller device to:
extract images from the export file; and
save the images as image files.

8. A non-transitory machine readable medium, on which are stored instructions, comprising instructions that when executed cause a machine to:
present a user interface configured for designing a plurality of artboards of varying sizes or shapes in an artboard canvas;
modify the plurality of artboards according to an instruction received via the user interface, the instruction applied to all of the plurality of artboards;
generate a plurality of export files, each corresponding to an artboard of the plurality of artboards and each comprising executable code for displaying images and text of the corresponding artboard in a browser, responsive to an instruction received via the user interface to export the plurality of artboards; and
export the plurality of export files to an ad server.

9. The machine readable medium of claim 8, wherein instructions that when executed cause the machine to generate the plurality of export files comprise instructions that when executed cause the machine to insert code in a scripting language into the export file.

10. The machine readable medium of claim 8, wherein the instructions that when executed cause the machine to generate the plurality of export files comprise instructions that when executed cause the machine to generate a first export file and a second export file, both corresponding to an artboard of the plurality of artboards, the first export file comprising executable code in a first programming language and the second export file comprising executable code in a second programming language.

11. The machine readable medium of claim 8, wherein the instructions that when executed cause the machine to generate the plurality of export files comprise instructions that when executed cause the machine to generate a first export file and a second export file, both corresponding to each artboard of the plurality of artboards, the first export file comprising executable code in a first programming language and the second export file comprising executable code in a second programming language.

12. The machine readable medium of claim 8, wherein the instructions that when executed cause the machine to generate the plurality of export files comprise instructions that when executed cause the machine to:
convert the artboards into a self-defining object notation; and
incorporate executable code in a scripting language to the self-defining object notation into the plurality of export files,
wherein the self-defining object notation is based on a subset of the scripting language.

13. The machine readable medium of claim 8, wherein the instructions further comprise instructions that when executed cause the machine to:
preview an export file of the plurality of export files in a browser executing on the computer system.

14. The machine readable medium of claim 8, wherein the instructions further comprise instructions that when executed cause the machine to:
extract images from the export file; and
save the images as image files.

15. A method of designing Internet banner ad units, comprising:
presenting a user interface in a computer system configured for designing a plurality of artboards of varying sizes or shapes in an artboard canvas;
modifying the plurality of artboards according to an instruction received via the user interface, the instruction applied to all of the plurality of artboards;
generating a plurality of export files, each corresponding to an artboard of the plurality of artboards and each comprising executable code for displaying images and text of the corresponding artboard in a browser, responsive to an instruction received via the user interface to export the plurality of artboards; and
exporting the plurality of export files to an ad server.

16. The method of claim 15, wherein generating the plurality of export files comprises inserting code in a scripting language into the export file.

17. The method of claim 15, wherein generating a plurality of export files comprises generating a first export file and a second export file, both corresponding to an artboard of the plurality of artboards, the first export file comprising executable code in a first programming language and the second export file comprising executable code in a second programming language.

18. The method of claim 15, wherein generating the plurality of export files comprises:
converting the plurality of artboards into a self-defining object notation; and
incorporating executable code in a scripting language to the self-defining object notation into the plurality of export files,
wherein the self-defining object notation is based on a subset of the scripting language.

19. The method of claim 15, further comprising:
previewing an export file of the plurality of export files in a browser.

20. The method of claim 15, further comprising:
extracting images from the plurality of artboards; and
saving the images as image files.
